(19) United States
(12) Patent Application Publication
(10) Pub. No.: US 2021/0360233 A1
(43) Pub. Date: Nov. 18, 2021

(54) ARTIFICIAL INTELLIGENCE BASED OPTIMAL BIT RATE PREDICTION FOR VIDEO CODING

(71) Applicant: Comcast Cable Communications, LLC, Philadelphia, PA (US)

(72) Inventors: Faisal Ishtiaq, Schaumburg, IL (US); Aravindakumar Venugopalan, Mount Laurel, NJ (US); Sivasubramaniam Renganathan, Maple Shade, NJ (US); Rajarajan Gandhi, Maple Shade, NJ (US); Alexander Giladi, Princeton, NJ (US); Alexander Balk, Mountlake Terrace, WA (US)

(21) Appl. No.: 15/930,174

(22) Filed: May 12, 2020

(51) Int. Cl. H04N 19/109; G06N 20/00; H04L 29/06; H04N 19/184; H04N 19/154

(52) U.S. Cl. CPC H04N 19/109; G06N 20/00; H04N 19/154; H04L 65/608; H04N 19/184; H04L 65/80

(57) ABSTRACT

Systems and methods are described for processing video data. The system may predict an optimal bit rate for a video segment that satisfies a desired level of quality. The desired level of quality may be associated with a quality metric. The encoder may predict the bit rate using a machine learning model trained based on an analysis of features extracted from video segments encoded with known bit rates. The trained machine learning model may then predict the optimal bit rate for a given video segment that achieves or satisfies the desired level of quality for the quality metric. The video segment may then be encoded based on the predicted bit rate.

### BACKGROUND

Bit rate selection for video during encoding is a tedious and time consuming process. Conventional solutions may be based on iterative approaches. These approaches encode video repeatedly at specific bit rates until descending to the optimal bit rate. The encoder then may repeat the process of encoding at different bit rates within the range until a desired level of quality is achieved. Existing approaches may be time consuming and/or inefficient.

### SUMMARY

Systems and methods are described for processing video data. An encoder may predict an optimal bit rate for a video segment for a desired level of quality. The encoder may predict the bit rate using a machine learning model. The machine learning model may be trained based on an analysis of features extracted from video segments that were encoded with known bit rates. The optimal bit rate may then be predicted for a given video segment that achieves or satisfies the desired level of quality. The prediction may be outputted by the trained machine learning model. The video segment may then be encoded at the optimal bitrate. The encoded video segment may then be sent via a content delivery network (CDN) to a decoder for playback of the video segment.

### BRIEF DESCRIPTION OF THE DRAWINGS

The following drawings show generally, by way of example, but not by way of limitation, various examples discussed in the present disclosure. In the drawings:

FIG. 1 shows an example system;

FIG. 2 shows an example video frame being processed;

FIG. 3 shows an example method;

FIG. 4 shows an example of aggregating features at the segment level;

FIG. 5 shows an example method;

FIG. 6 shows an example method;

FIG. 7 shows an example method;

FIG. 8 shows an example method; and

FIG. 9 depicts an example computing device.

### DETAILED DESCRIPTION OF ILLUSTRATIVE EMBODIMENTS

Systems and methods are described for processing video. A video encoder may predict an optimal bit rate. The predicted bit rate may be optimal for a desired level of quality for a video segment. The predicted bit rate may be used when encoding the video segment. The bit rate may be predicted using artificial intelligence (AI). The AI may comprise a machine learning model. Machine learning models may identify patterns in training data, and the identified patterns may be used to determine predictions about new data. The techniques described herein may train a machine learning model using video features extracted from one or more video segments. Using the trained machine learning model, an optimal bit rate for a given video segment may be predicted.

Iterative approaches may be used for determining optimal bit rates. Iterative approaches may be based on the Newton Raphson approach. Bit rate selection for video encoding based on iterative approaches may be tedious and time-consuming. Iterative approaches encode video repeatedly at specific bit rates until descending to the optimal bit rate, as validated by a video quality measurement tool each iteration. For example, an encoder may start the encoding process at the middle of a bit rate range (e.g., a range of 300 kilobits per second (kbps)-80 megabits per second (Mbps)). The selected rate in the middle of the range may be referred to as a trial bit rate. After encoding video at the trial bit rate, the encoder may determine the video quality of the encoder video by evaluating one or more quality metrics such as peak signal-to-noise ratio (PSNR) or structural similarity index (SSIM). The encoder then may repeat the process of encoding at different bit rates within the range until a desired level of quality is achieved. Using the trained machine learning model according to the techniques described herein, an iterative approach for determining a bit rate can be avoided by instead having the machine learning model predict the bit rate.

Video used in the embodiments described herein may comprise video frames or other images. Video frames may comprise pixels. A pixel may comprise a smallest controllable element of a video frame. A video frame may comprise bits for controlling each associated pixel. A portion of the bits for an associated pixel may control a luma value (e.g., light intensity) of each associated pixel. A portion of the bits for an associated pixel may control one or more chrominance value (e.g., color) of the pixel. The video may be processed by a video codec comprising an encoder and decoder. The codecs described herein may be based on standards including but not limited to H.265/MPEG-High Efficiency Video Coding (HEVC), H.264/MPEG-Advanced Video Coding (AVC), or Versatile Video Coding (VVC). When video data is transmitted from one location to another, the encoder may encode the video (e.g., into a compressed format) at a particular bit rate using a compression technique prior to transmission. The decoder may receive the compressed video and decode the video (e.g., into a decompressed format).

Encoding video may comprise partitioning a frame of video data into a plurality of coding tree units (CTUs) or macroblocks that each comprising a plurality of pixels. The CTUs or macroblock may be partitioned into coding units (CUs) or coding blocks. The terms coding unit and coding block may be used interchangeably herein. The encoder may generate a prediction of each current CU based on previously encoded data. The prediction may comprise intra-prediction, which is based on previously encoded data of the current frame being encoded. The prediction may comprise inter-prediction, which is based on previously encoded data of a previously encoded reference frame. The inter-prediction stage may comprise determining a prediction unit (PU) (e.g., a prediction area) using motion compensation by determining a PU that best matches a prediction region in the CU. The encoder may generate a residual signal by determining a difference between the determined PU from the prediction region in the CU. The residual signals may then be transformed using, for example, a discrete cosine transform (DCT), which may generate coefficients associated with the residuals. The encoder may then perform a quantization process to quantize the coefficients. The transformation and quantization processes may be performed on transform units (TUs) based on partitions of the CUs. The compressed bitstream comprising video frame data may then be transmitted by the encoder. The transmitted compressed bitstream may comprise the quantized coefficients and information to enable the decoder to regenerate the prediction blocks, such as motion vector associated with the motion compensation. The decoder may receive the compressed bitstream and may decode the compressed bitstream to regenerate the video content.

Prior to performing the encoding process described above, the encoder may predict an optimal bit rate. The optimal bit rate may be determined using a machine learning model. The machine learning model may be trained based on an analysis of features extracted from video segments with known bit rates. During training, the encoder may extract information associated with a video segment. The information may comprise features or characteristics of the video segment. The machine learning model may be trained using a machine learning algorithm to correlate the extracted information with the known optimal bit rate. As a result, the machine learning model learns which optimal bit rates to associate with the features extracted from a video segment.

The features may first be extracted at the frame level. The features may comprise a color profile, an edge histogram profile, scene cut information, a shot feature, a spatial nature of the one or more frames, a temporal nature of the one or more frames, a chroma level, a luma level, a brightness value, a contrast value, a sharpness value, a texture value, a motion factor, a color richness value, or a noise value. The variation of these frame level video characteristics with respect to the previous frames and subsequent frames may then be determined.

Statistics associated with the features at the frame level may then be analyzed. The statistics associated with the features at the frame level may be aggregated at the video segment level. The aggregation may be based on at least one of mean, standard deviation, count, or skew. A data set may then be generated based on the aggregation for one or more video segments.

This data set may then be used to train a machine learning model. The machine learning model may receive the data set generated for a video segment along with information indicating the optimal bit rate that was arrived at, for example, using the existing iterative Newton Raphson approach for bit rate determination. During training, the machine learning model may learn the correlation, for various resolutions, between the optimal bit rate (arrived at, for example, using the existing iterative Newton Raphson) and the features of a video segment in the data set.

Once the machine learning model has been trained to learn these correlations, the machine learning model may be used to predict the optimal bit rate for a newly received video segment. The trained machine learning model may then predict, based on a desired level of quality, the optimal bit rate for the video segment. The desired level of quality may be associated with one or more quality metrics that indicate a Mean Opinion Score (MOS). The one or more quality metrics may comprise peak signal-to-noise ratio (PSNR) or structural similarity index (SSIM). Given the one or more quality metrics, the system may predict the optimal bit rate.

Features may first be extracted from frames in the video segment. Statistics associated with the features at the frame level may then be aggregated at the video segment level. A data frame may be generated comprising the information indicating the features associated with the video segment. The data frame may then be sent to the machine learning model to determine an optimal bit rate based on the information in the data frame. Rather than merely provide a classification of a bit rate using a predetermined classification such as high bit rate, low bit rate, a range of bit rates, etc., the machine learning model may predict an exact optimal bit rate. The optimal bit rate information is then sent to the encoder, which can then encode the video segment with the optimal bit rate.

The encoded video segment with the optimal bitrate may then be sent via a content delivery network (CDN) to a decoder for playback of the video segment. The techniques described herein are applicable for any video delivery method including but not limited to Dynamic Adaptive Streaming over Hypertext Transfer Protocol (HTTP) (DASH), HTTP Live Streaming (HLS), the QAM digital television standard, and adaptive bit rate (ABR) streaming. The machine learning model may predict the optimal bit rate for various streams encoded at different resolutions for use in CDNs that provide ABR streaming. Separate models may be trained for the different resolutions used in ABR (standard definition (SD) video segments, high definition (HD) video segments, 8 bit video segments, or 10 bit video segments).

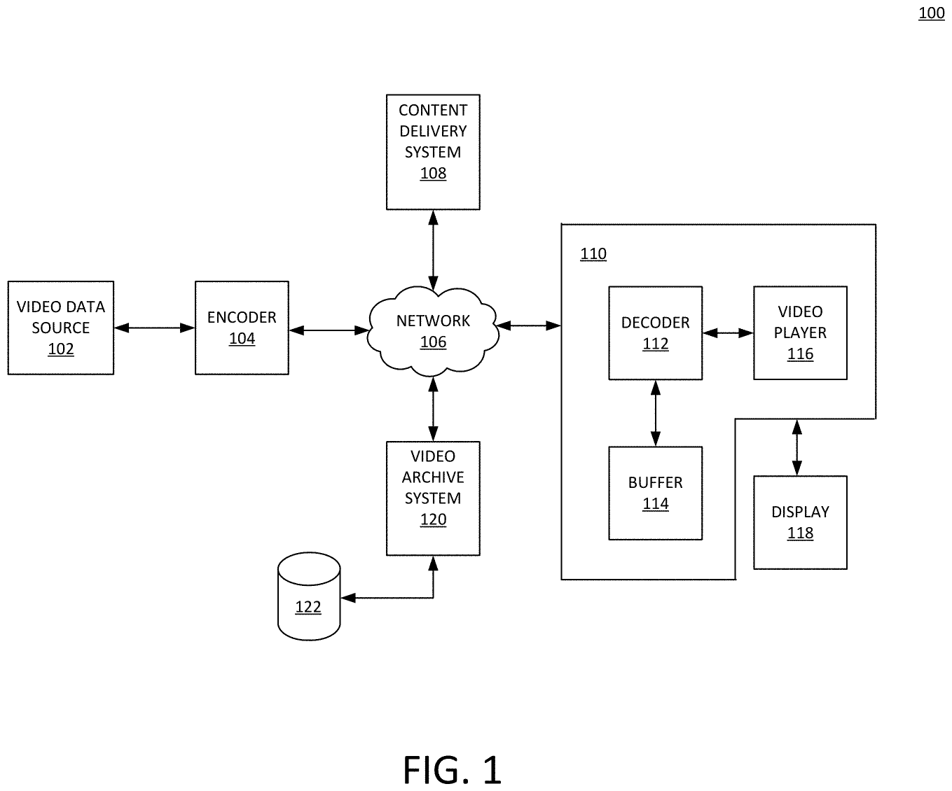

FIG. 1 shows system 100 configured for video processing. The system 100 may comprise a video data source 102, an encoder 104, a content delivery system 108, a computing device 110, and a video archive system 120. The video archive system 120 may be communicatively connected to a database 122 to store archived video data.

The video data source 102, the encoder 104, the content delivery system 108, the computing device 110, the video archive system 120, and/or any other component of the system 100 may be interconnected via a network 106. The network 106 may comprise a wired network, a wireless network, or any combination thereof. The network 106 may comprise a public network, such as the Internet. The network 106 may comprise a private network, such as a content provider's distribution system. The network 106 may communicate using technologies such as WLAN technology based on the Institute of Electrical and Electronics Engineers (IEEE) 802.11 standard, wireless cellular technology, Bluetooth, coaxial cable, Ethernet, fiber optics, microwave, satellite, Public Switched Telephone Network (PTSN), Digital Subscriber Line (DSL), BPL, or any other appropriate technologies.

The video data source 102 may comprise a headend, a video on-demand server, a cable modem termination system, the like, and/or any combination of the foregoing. The video data source 102 may provide uncompressed, raw video data comprising a sequence of frames. The video data source 102 and the encoder 104 may be incorporated as a single device and/or may be co-located at a premises. The video data source 102 may provide the uncompressed video data based on a request for the uncompressed video data, such as a request from the encoder 104, the computing device 110, the content delivery system 108, and/or the video archive system 120.

The content delivery system 108 may receive a request for video data from the computing device 110. The content delivery system 108 may authorize/authenticate the request and/or the computing device 110 from which the request originated. The request for video data may comprise a request for a channel, a video on-demand asset, a website address, a video asset associated with a streaming service, the like, and/or any combination of the foregoing. The video data source 102 may transmit the requested video data to the encoder 104.

The encoder 104 may encode (e.g., compress) the video data. The encoder 104 may transmit the encoded video data to the requesting component, such as the content delivery system 108 or the computing device 110. The content delivery system 108 may transmit the requested encoded video data to the requesting computing device 110. The video archive system 120 may provide a request for encoded video data. The video archive system 120 may provide the request to the encoder 104 and/or the video data source 102. Based on the request, the encoder 104 may receive the corresponding uncompressed video data. The encoder 104 may encode the uncompressed video data to generate the requested encoded video data. The encoded video data may be provided to the video archive system 120. The video archive system 120 may store (e.g., archive) the encoded video data from the encoder 104. The encoded video data may be stored in the database 122. The stored encoded video data may be maintained for purposes of backup or archive. The stored encoded video data may be stored for later use as “source” video data, to be encoded again and provided for viewer consumption. The stored encoded video data may be provided to the content delivery system 108 based on a request from a computing device 110 for the encoded video data. The video archive system 120 may provide the requested encoded video data to the computing device 110.

The computing device 110 may comprise a decoder 112, a buffer 114, and a video player 116. The computing device 110 (e.g., the video player 116) may be communicatively connected to a display 118. The display 118 may be a separate and discrete component from the computing device 110, such as a television display connected to a set-top box. The display 118 may be integrated with the computing device 110. The decoder 112, the video player 116, the buffer 114, and the display 118 may be realized in a single device, such as a laptop or mobile device. The computing device 110 (and/or the computing device 110 paired with the display 118) may comprise a television, a monitor, a laptop, a desktop, a smart phone, a set-top box, a cable modem, a gateway, a tablet, a wearable computing device, a mobile computing device, any computing device configured to receive and/or playback video, the like, and/or any combination of the foregoing. The decoder 112 may decompress/decode the encoded video data. The encoded video data may be received from the encoder 104. The encoded video data may be received from the content delivery system 108, and/or the video archive system 120.

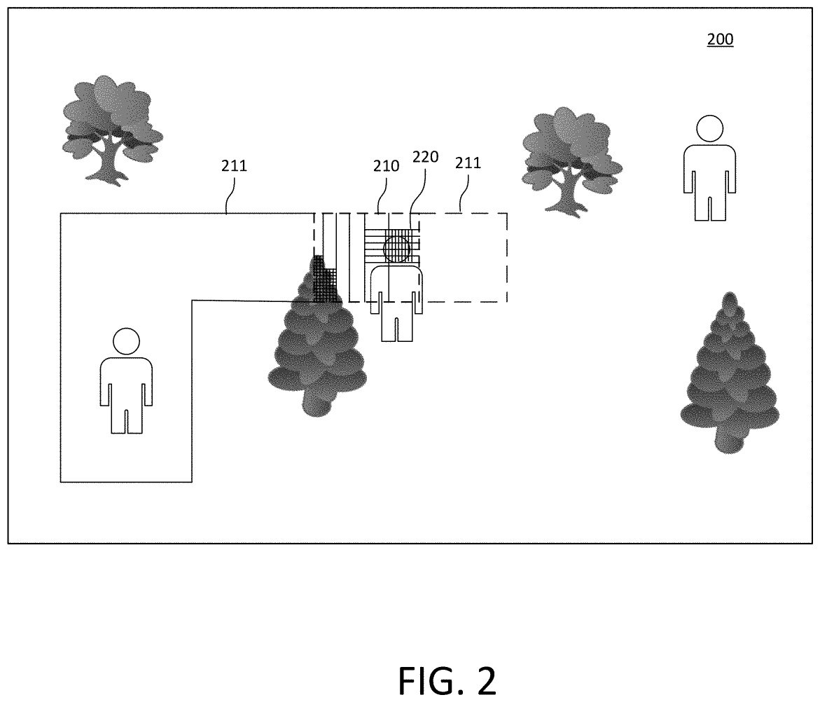

FIG. 2 shows an example video frame 200 being processed. The video frame 200 may be part of a video segment. The video frame 200 may be partitioned into one or more slices 211. The slice 211 may be further partitioned into one or more CTUs 210 and 211 (which may also be referred to as macroblocks depending on the standard associated with the encoder). Each CTU 210 and 211 may comprise features such as a color profile, an edge histogram profile, scene cut information, a shot feature, a spatial nature of the one or more frames, a temporal nature of the one or more frames, a chroma level, a luma level, a brightness value, a contrast value, a sharpness value, a texture value, a motion factor, a color richness value, or a noise value. The encoder may allocate more data for encoding more detailed CTUs such as CTU 210, which comprises details 220 associated with a person's face. CTU 211 comprises less detail, such as the background of the video frame 200, and accordingly the encoder may allocate less data for encoding CTU 211. Accordingly, the encoder determines the optimal bit rate for encoding each CTU 210 and 211 for a video frame 200.

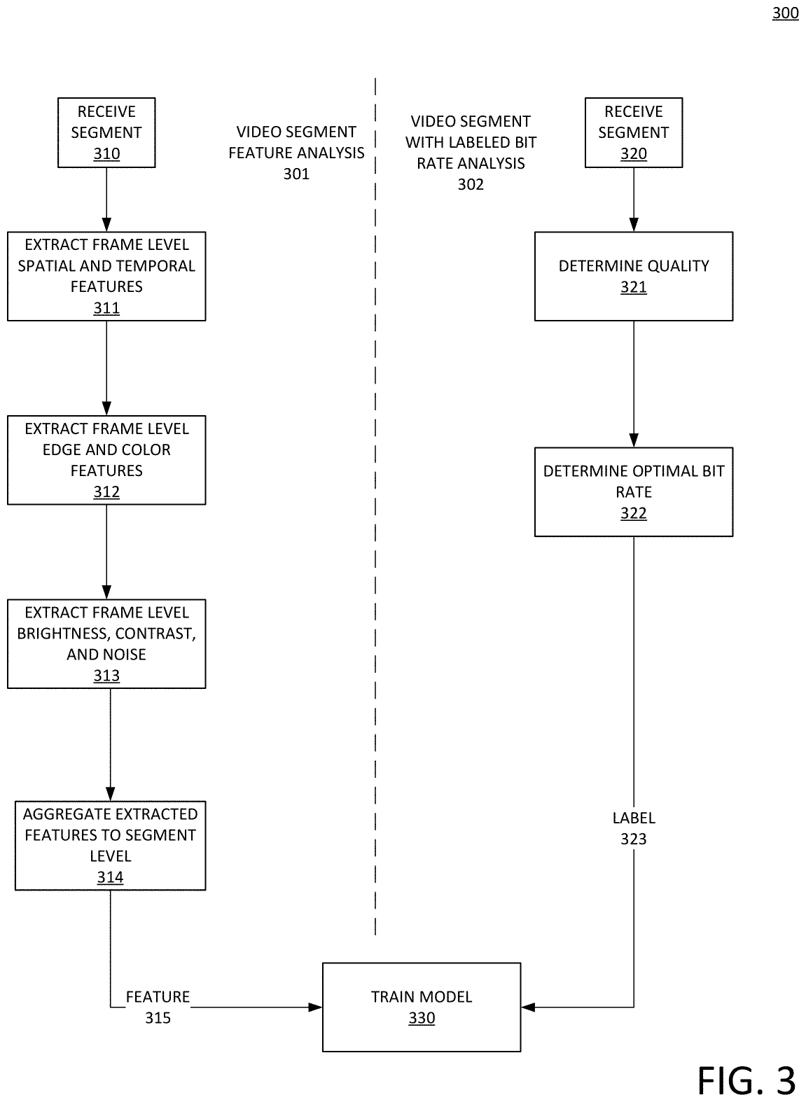

FIG. 3 shows an example method 300 for training a machine learning model. The method 300 of FIG. 3, may be performed by the encoder 104 or computing device 110 of FIG. 1. While each step in the method 300 of FIG. 3 is shown and described separately, multiple steps may be executed in a different order than what is shown, in parallel with each other, or concurrently with each other. FIG. 3 shows two portions of the model training process, the feature analysis 301 portion of the model training process and the analysis of video segments labeled with known bit rates 302.

As part of the feature analysis 301 portion of the model training process, a video segment may be received at step 310. At step 311, frame level features or characteristics such as spatial and temporal features may be extracted, such as the frame level features depicted in FIG. 2. These features may be associated with coding unit features processed for intra-prediction and inter-prediction by an encoder such as an HEVC H.265/MPEG based codec. At step 312, frame level features such as edge and color features may be extracted, such as the frame level features depicted in FIG. 2. These features may comprise a color richness value, a chroma level, a luma level, a color profile, an edge histogram profile, scene cut information, or a shot feature. At step 313, frame level features such as brightness, contrast, and noise features may be extracted, such as the frame level features depicted in FIG. 2. These features may comprise a brightness value, a contrast value, a sharpness value, a texture value, a motion factor, or a noise value. At step 314, the features extracted in steps 311, 312 and 313, may be aggregated to the video segment level. At step 315, the aggregated features may then be sent to a machine learning engine to train the machine learning model. The aggregated features may be represented by a feature vector. The feature vector may comprise a summary representation of the values associated with the extracted features. A data frame comprising the feature vector associated with the aggregated features may be sent to the machine learning model in step 315.

As part of the analysis of video segments labeled with known bit rates 302 portion of the model training process, the same video segment, received at step 310, may be received at step 320. At step 321, the quality value of the video segment may be determined. A quality measurement tool may be used at this step to determine the quality necessary to provide a viewer with a quality viewing experience of the video segment. At step 322, the optimal bit rate of the video segment may be determined. The optimal bit rate determination may be based on a conventional iterative approach such as the Newton Raphson approach. At step 323, a label indicative of the optimal bit rate of the video segment may then be sent to the machine learning engine to train the machine learning model.

At step 330, the machine learning model may be trained. A machine learning algorithm may be used to train the machine learning model. Machine learning algorithms that may be used for training may include but are not limited to: decision trees, support vector machines, k-nearest neighbors, artificial neural networks (e.g., artificial neural networks based on a long short-term memory (LSTM) artificial recurrent neural network (RNN) architecture), or Bayesian networks. The machine learning model may be trained using the machine learning algorithm to correlate the aggregated features received in step 315 with the labeled optimal bit rate received in step 323. As a result, the machine learning model learns which optimal bit rates to associate with the features extracted from the video segment.

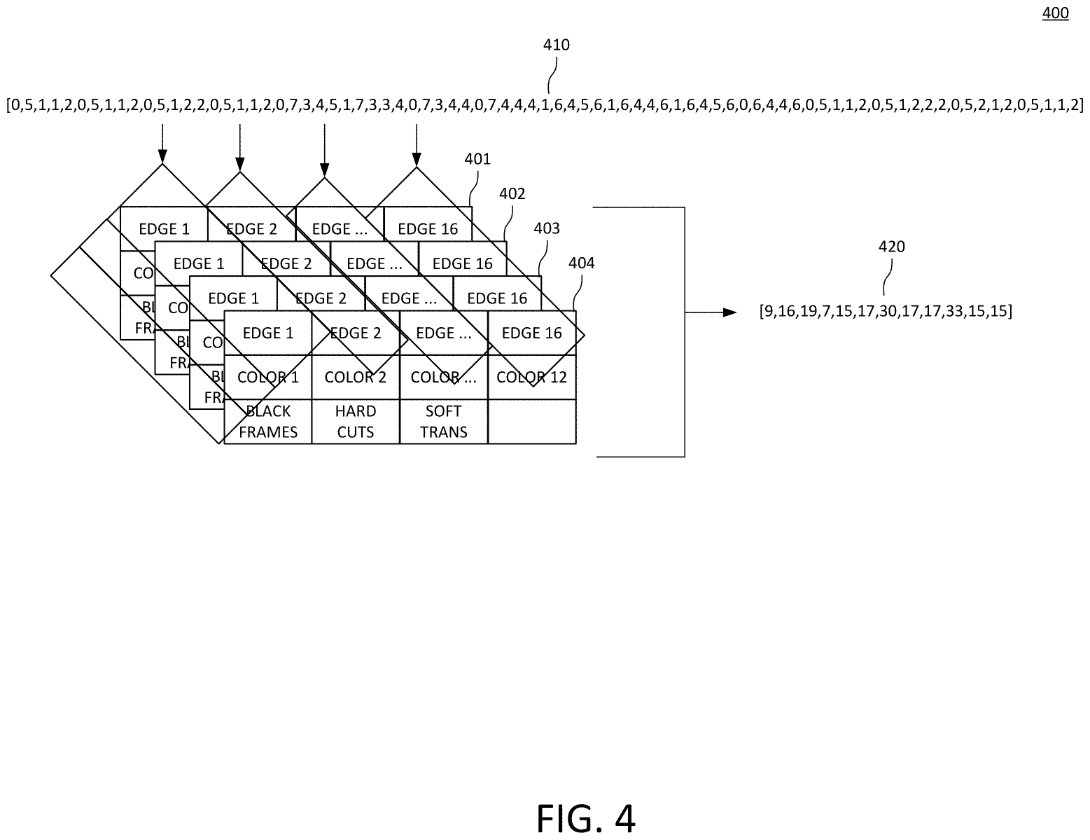

FIG. 4 shows an example of aggregating 400 video frame features at the segment level. The example of FIG. 4 shows video frames 401, 402, 403, and 404. Characteristics of the video frames 401, 402, 403, and 404 may be extracted by the encoder for analysis by the machine learning model described herein. The characteristics may comprise features such as a color profile, an edge histogram profile, scene cut information, a shot feature, a spatial nature of the one or more frames, a temporal nature of the one or more frames, a chroma level, a luma level, a brightness value, a contrast value, a sharpness value, a texture value, a motion factor, a color richness value, or a noise value. In the example of FIG. 4, characteristics associated with the edges, colors, black frames, hard cuts, and soft transitions in the video frames 401, 402, 403, and 404 are extracted into a feature vector 410. The feature vector 410 may be aggregated to the video segment level to generate feature vector 420. The aggregation may be based on a mathematical aggregation comprising at least one of: mean, standard deviation, count, or skew. A data frame inputted into the machine learning model described herein may comprise the feature vector 420. The data frame may be sent to the machine learning model trained in FIG. 3.

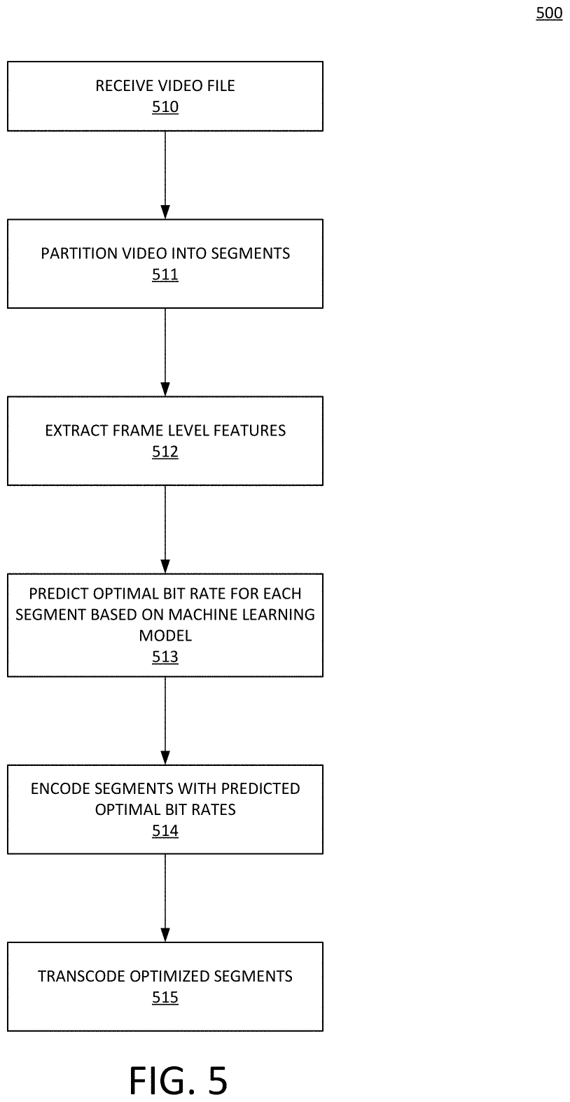

FIG. 5 shows an example method 500 for predicting an optimal bit rate once the machine learning model has been trained. The method 500 of FIG. 5, may be performed by the encoder 104 or computing device 110 of FIG. 1 using the machine learning model trained using the method depicted in FIG. 3. While each step in the method 500 of FIG. 5 is shown and described separately, multiple steps may be executed in a different order than what is shown, in parallel with each other, or concurrently with each other.

At step 510, a new video file may be received. At step 511, the video file may be partitioned into segments. At step 512, frame level features may be extracted. The frame level features may be the features depicted in FIGS. 2 and 4. At step 513, the optimal bit rate for each segment may be predicted for each video segment using the machine learning model trained using the method depicted in FIG. 3. At step 514, the video segments may be encoded using the predicted optimal bit rates. At step 515, the video segments with the optimized bit rates may be transcoded and prepared for delivery via the CDN to a user computing device for viewing.

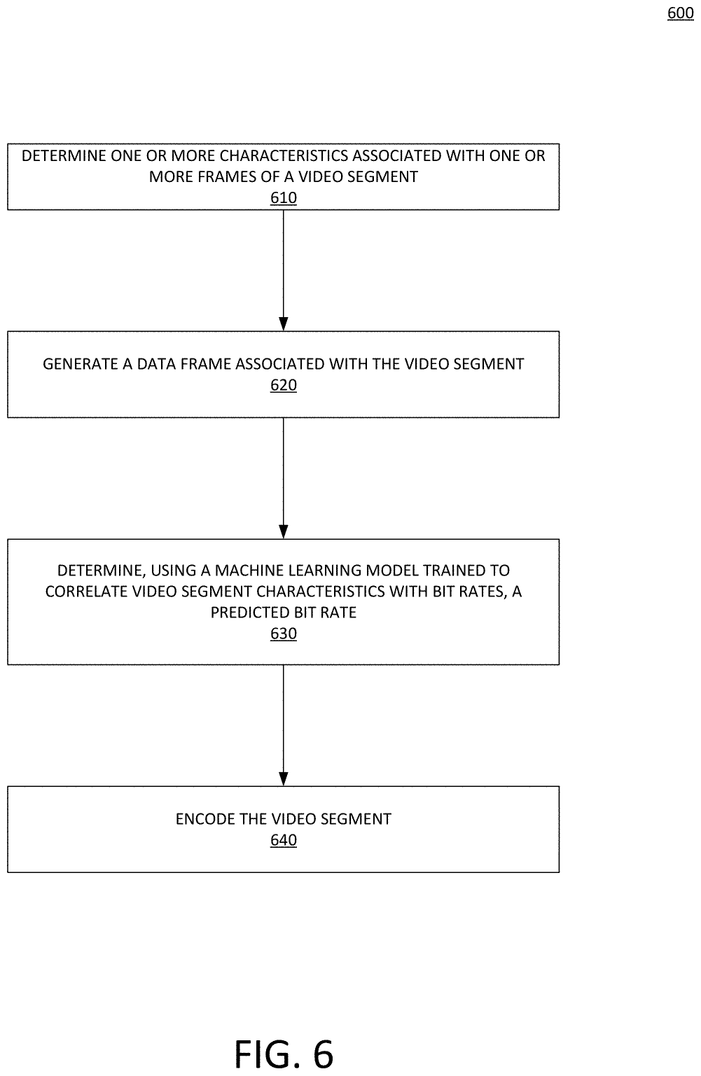

FIG. 6 shows an example method 600. The method 600 of FIG. 6, may be performed by the encoder 104 or computing device 110 of FIG. 1. While each step in the method 600 of FIG. 6 is shown and described separately, multiple steps may be executed in a different order than what is shown, in parallel with each other, or concurrently with each other.

At step 610, an encoder may determine one or more characteristics associated with one or more frames of a video segment. The one or more characteristics may comprise at least one of: a color profile, an edge histogram profile, scene cut information, a shot feature, a spatial nature of the one or more frames, a temporal nature of the one or more frames, a chroma level, a luma level, a brightness value, a contrast value, a sharpness value, a texture value, a motion factor, a color richness value, or a noise value.

At step 620, the encoder may generate a data frame associated with the video segment. The data frame may be generated based on an aggregation of the one or more characteristics. The data frame may comprise a feature vector indicative of the one or more characteristics. The aggregation may be based on a mathematical aggregation comprising at least one of: mean, standard deviation, count, or skew.

At step 630, the encoder may determine a predicted bit rate. The predicted bit rate may be determined based on the data frame and a quality value and using a machine learning model trained to correlate video segment characteristics with bit rates. The predicted bit rate may achieve or satisfy the quality value. The quality value may indicate an MOS. The quality value may comprise a target value for at least one of PSNR or SSIM. Determining the predicted bit rate may comprise inputting the feature vector into the machine learning model and correlating the one or more characteristics with an optimal bit rate for the one or more characteristics. The machine learning model may have been trained based on correlating a training video segment, encoded with a known bit rate, with one or more characteristics extracted from the training video segment.

At step 640, the encoder may encode the video segment. The video segment may be encoded based on the predicted bit rate. The predicted bit rate may comprise an optimal number of bits per second allocated for the encoding. This predicted bit rate may lead to large savings in the CPU cycles needed to arrive at the optimal bitrate for the video segment.

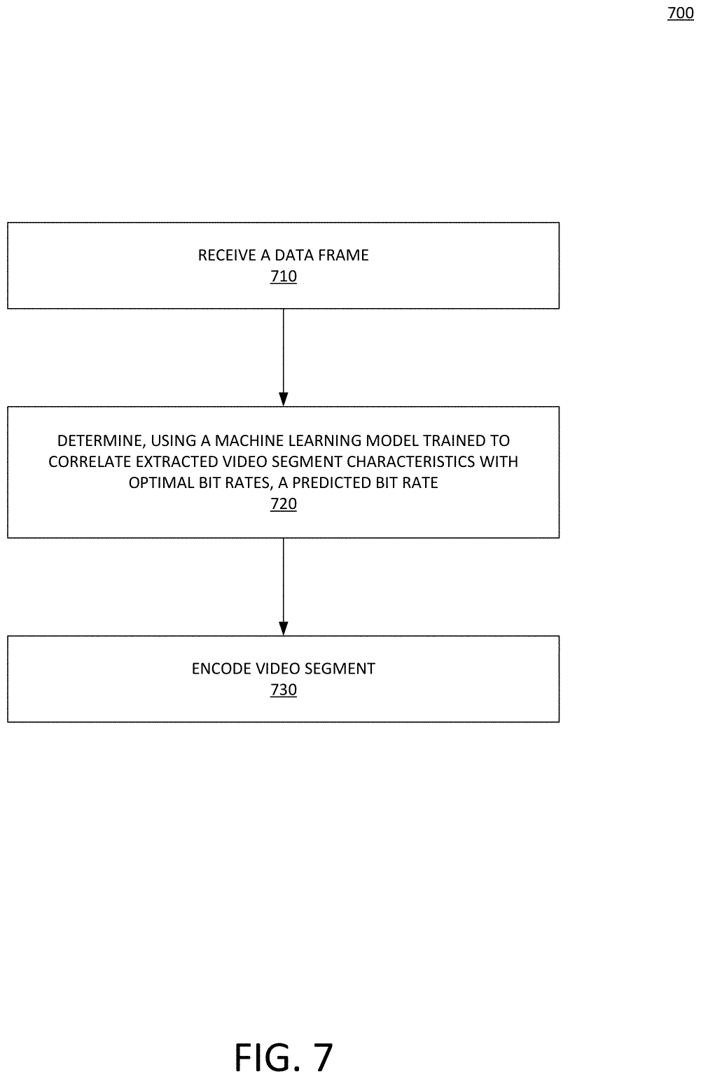

FIG. 7 shows an example method 700. The method 700 of FIG. 7, may be performed by the encoder 104 or computing device 110 of FIG. 1. While each step in the method 700 of FIG. 7 is shown and described separately, multiple steps may be executed in a different order than what is shown, in parallel with each other, or concurrently with each other.

At step 710, an encoder may receive a data frame. The data frame may comprise information that is indicative of an aggregation of one or more characteristics extracted from one or more frames of a video segment. The one or more characteristics may comprise at least one of: a color profile, an edge histogram profile, scene cut information, a shot feature, a spatial nature of the one or more frames, a temporal nature of the one or more frames, a chroma level, a luma level, a brightness value, a contrast value, a sharpness value, a texture value, a motion factor, a color richness value, or a noise value. The data frame may comprise a feature vector indicative of the one or more characteristics. The aggregation may be based on a mathematical aggregation comprising at least one of: mean, standard deviation, count, or skew.

At step 720, the encoder may determine a predicted bit rate. The predicted bit rate may be determined based on the received data frame and a quality value and using a machine learning model trained to correlate extracted video segment characteristics with optimal bit rates. The predicted bit rate may achieve or satisfy the quality value. The predicted bit rate may comprise an optimal number of bits per second to allocate for encoding. The quality value may indicate an MOS. The quality value may comprise a target value for at least one of PSNR or SSIM. Determining the predicted bit rate may comprise inputting the feature vector into the machine learning model and correlating the one or more characteristics with an optimal bit rate for the one or more characteristics. The machine learning model may have been trained based on correlating a training video segment, encoded with a known bit rate, with one or more characteristics extracted from the training video segment.

At step 730, the encoder may encode the video segment. The video segment may be encoded based on the predicted bit rate. The predicted bit rate may comprise an optimal number of bits per second allocated for the encoding. This predicted bit rate may lead to large savings in the CPU cycles needed to arrive at the optimal bitrate for the video segment.

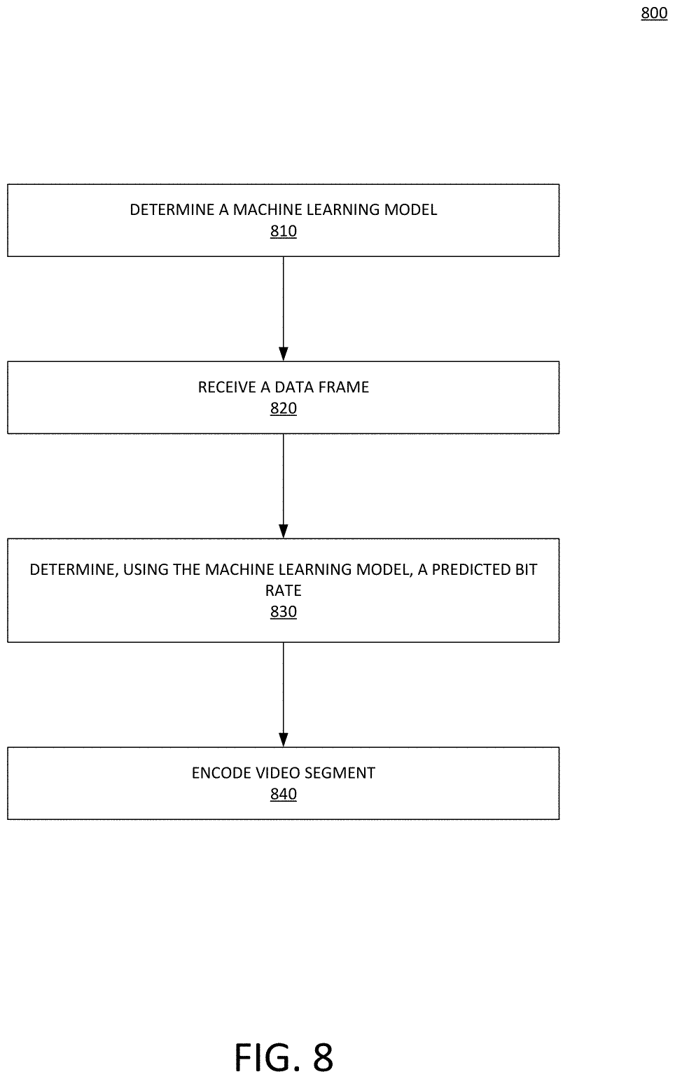

FIG. 8 shows an example method 800. The method 800 of FIG. 8, may be performed by the encoder 104 or computing device 110 of FIG. 1. While each step in the method 800 of FIG. 8 is shown and described separately, multiple steps may be executed in a different order than what is shown, in parallel with each other, or concurrently with each other.

At step 810, an encoder may determine a machine learning model. The machine learning model may be determined based on correlating a first video segment encoded with a first bit rate with one or more characteristics extracted from the first video segment. The one or more characteristics may comprise at least one of: a color profile, an edge histogram profile, scene cut information, a shot feature, a spatial nature of the one or more frames, a temporal nature of the one or more frames, a chroma level, a luma level, a brightness value, a contrast value, a sharpness value, a texture value, a motion factor, a color richness value, or a noise value.

At step 820, the encoder may receive a data frame. The received data frame may comprise information that is indicative of an aggregation of one or more characteristics extracted from one or more frames of a second video segment. The data frame may comprise a feature vector indicative of the one or more characteristics. The aggregation may be based on a mathematical aggregation comprising at least one of: mean, standard deviation, count, or skew.

At step 830, the encoder may determine a predicted bit rate. The predicted bit rate may be determined based on the received data frame and a quality value and using the machine learning model. The predicted bit rate may achieve or satisfy the quality value. The quality value may indicate an MOS. The quality value may comprise a target value for at least one of PSNR or SSIM. Determining the predicted bit rate may comprise inputting the feature vector into the machine learning model and correlating the one or more characteristics with an optimal bit rate for the one or more characteristics.

At step 840, the encoder may encode the second video segment. The second video segment may be encoded based on the predicted bit rate. The predicted bit rate may comprise an optimal number of bits per second allocated for the encoding. This predicted bit rate may lead to large savings in the CPU cycles needed to arrive at the optimal bitrate for the video segment.

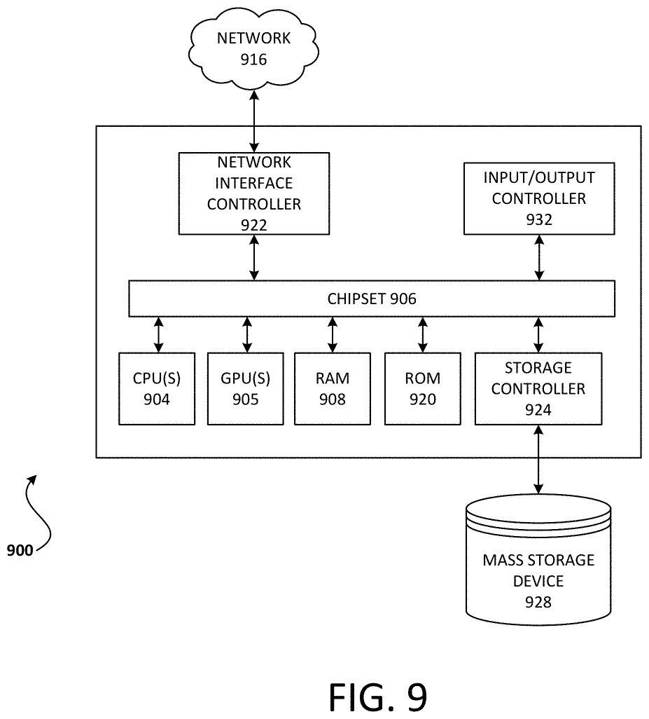

FIG. 9 depicts a computing device 900 that may be used in various aspects, such as the servers, modules, and/or devices depicted in FIG. 1. With regard to the example architectures of FIG. 1, the devices may each be implemented in an instance of a computing device 900 of FIG. 9. The computer architecture shown in FIG. 9 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 3 and 5-8.

The computing device 900 may include a baseboard, or “motherboard,” which is a printed circuit board to which a multitude of components or devices may be connected by way of a system bus or other electrical communication paths. One or more central processing units (CPUs) 904 may operate in conjunction with a chipset 906. The CPU(s) 904 may be standard programmable processors that perform arithmetic and logical operations necessary for the operation of the computing device 900.

The CPU(s) 904 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 904 may be augmented with or replaced by other processing units, such as GPU(s) 905. The GPU(s) 905 may comprise processing units specialized for but not necessarily limited to highly parallel computations, such as graphics and other visualization-related processing.

A chipset 906 may provide an interface between the CPU(s) 904 and the remainder of the components and devices on the baseboard. The chipset 906 may provide an interface to a random access memory (RAM) 908 used as the main memory in the computing device 900. The chipset 906 may further provide an interface to a computer-readable storage medium, such as a read-only memory (ROM) 920 or non-volatile RAM (NVRAM) (not shown), for storing basic routines that may help to start up the computing device 900 and to transfer information between the various components and devices. ROM 920 or NVRAM may also store other software components necessary for the operation of the computing device 900 in accordance with the aspects described herein.

The computing device 900 may operate in a networked environment using logical connections to remote computing nodes and computer systems through local area network (LAN) 916. The chipset 906 may include functionality for providing network connectivity through a network interface controller (NIC) 922, such as a gigabit Ethernet adapter. A NIC 922 may be capable of connecting the computing device 900 to other computing nodes over a network 916. It should be appreciated that multiple NICs 922 may be present in the computing device 900, connecting the computing device to other types of networks and remote computer systems.

The computing device 900 may be connected to a mass storage device 928 that provides non-volatile storage for the computer. The mass storage device 928 may store system programs, application programs, other program modules, and data, which have been described in greater detail herein. The mass storage device 928 may be connected to the computing device 900 through a storage controller 924 connected to the chipset 906. The mass storage device 928 may consist of one or more physical storage units. A storage controller 924 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 900 may store data on a mass storage device 928 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 928 is characterized as primary or secondary storage and the like.

For example, the computing device 900 may store information to the mass storage device 928 by issuing instructions through a storage controller 924 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 900 may further read information from the mass storage device 928 by detecting the physical states or characteristics of one or more particular locations within the physical storage units.

In addition to the mass storage device 928 described herein, the computing device 900 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 900.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 928 depicted in FIG. 9, may store an operating system utilized to control the operation of the computing device 900. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 928 may store other system or application programs and data utilized by the computing device 900.

The mass storage device 928 or other computer-readable storage media may also be encoded with computer-executable instructions, which, when loaded into the computing device 900, transforms the computing device from a general-purpose computing system into a special-purpose computer capable of implementing the aspects described herein. These computer-executable instructions transform the computing device 900 by specifying how the CPU(s) 904 transition between states, as described herein. The computing device 900 may have access to computer-readable storage media storing computer-executable instructions, which, when executed by the computing device 900, may perform the methods described in relation to FIGS. 3 and 5-8.

A computing device, such as the computing device 900 depicted in FIG. 9, may also include an input/output controller 932 for receiving and processing input from a number of input devices, such as a keyboard, a mouse, a touchpad, a touch screen, an electronic stylus, or other type of input device. Similarly, an input/output controller 932 may provide output to a display, such as a computer monitor, a flat-panel display, a digital projector, a printer, a plotter, or other type of output device. It will be appreciated that the computing device 900 may not include all of the components shown in FIG. 9, may include other components that are not explicitly shown in FIG. 9, or may utilize an architecture completely different than that shown in FIG. 9.

As described herein, a computing device may be a physical computing device, such as the computing device 900 of FIG. 9. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

1. A method comprising:
determining one or more characteristics associated with one or more frames of a video segment;
generating, based on an aggregation of the one or more characteristics, data associated with the video segment;
determining, based on the data, based on a quality value, and using a machine learning model trained to correlate video segment characteristics with bit rates, a predicted bit rate that satisfies the quality value; and
encoding, based on the predicted bit rate, the video segment.

2. The method of claim 1, wherein the quality value indicates at least one of: a Mean Opinion Score (MOS), a peak signal-to-noise ratio (PSNR), or a structural similarity index (SSIM).

3. The method of claim 1, wherein the data comprises a feature vector indicative of the one or more characteristics.

4. The method of claim 3, wherein the determining the predicted bit rate comprises inputting the feature vector into the machine learning model.

5. The method of claim 1, wherein the one or more characteristics comprise at least one of: a color profile, an edge histogram profile, scene cut information, a shot feature, a spatial nature of the one or more frames, a temporal nature of the one or more frames, a chroma level, a luma level, a brightness value, a contrast value, a sharpness value, a texture value, a motion factor, a color richness value, or a noise value.

6. The method of claim 1, wherein the aggregation is based on a mathematical aggregation comprising at least one of: mean, standard deviation, count, or skew.

7. The method of claim 1, wherein the determining the predicted bit rate comprises correlating the one or more characteristics with an optimal bit rate for the one or more characteristics.

8. The method of claim 1, wherein training the machine learning model comprises correlating a training video segment, encoded with a known bit rate, with one or more characteristics extracted from the training video segment.

9. The method of claim 1, wherein the predicted bit rate comprises an optimal number of bits per second allocated for the encoding.

10. A method comprising:
receiving data comprising information indicating an aggregation of one or more characteristics extracted from one or more frames of a video segment;
determining, based on the received data, based on a quality value, and using a machine learning model trained to correlate extracted video segment characteristics with optimal bit rates, a predicted bit rate that satisfies the quality value; and
encoding, based on the predicted bit rate, the video segment.

11. The method of claim 10, wherein the predicted bit rate comprises an optimal number of bits per second to allocate for encoding.

12. The method of claim 10, wherein the quality value indicates at least one of: a Mean Opinion Score (MOS), a peak signal-to-noise ratio (PSNR), or a structural similarity index (SSIM).

13. The method of claim 10, wherein the one or more characteristics comprise at least one of: a color profile, an edge histogram profile, scene cut information, a shot feature, a spatial nature of the one or more frames, a temporal nature of the one or more frames, a chroma level, a luma level, a brightness value, a contrast value, a sharpness value, a texture value, a motion factor, a color richness value, or a noise value.

14. The method of claim 10, wherein the aggregation is based on a mathematical aggregation comprising at least one of: mean, standard deviation, count, or skew.

15. The method of claim 10, wherein the data comprises a feature vector indicative of the one or more characteristics, wherein the determining the predicted bit rate comprises inputting the feature vector into the machine learning model.

16. The method of claim 10, wherein training the machine learning model comprises correlating a training video segment, encoded with a known bit rate, with one or more characteristics extracted from the training video segment.

17. A method comprising:
determining, based on correlating a first video segment encoded with a first bit rate with one or more characteristics extracted from the first video segment, a machine learning model;
receiving data, indicative of an aggregation of one or more characteristics extracted from one or more frames of a second video segment;
determining, based on the received data, based on a quality value, and using the machine learning model, a predicted bit rate that satisfies the quality value; and
encoding, based on the predicted bit rate, the second video segment.

18. The method of claim 17, wherein the one or more characteristics comprise at least one of: a color profile, an edge histogram profile, scene cut information, a shot feature, a spatial nature of the one or more frames, a temporal nature of the one or more frames, a chroma level, a luma level, a brightness value, a contrast value, a sharpness value, a texture value, a motion factor, a color richness value, or a noise value.

19. The method of claim 17, wherein the aggregation is based on a mathematical aggregation comprising at least one of: mean, standard deviation, count, or skew.

20. The method of claim 17, wherein the data comprises a feature vector indicative of the one or more characteristics, wherein the determining the predicted bit rate comprises inputting the feature vector into the machine learning model.

21. The method of claim 17, wherein the quality value indicates at least one of: a Mean Opinion Score (MOS), a peak signal-to-noise ratio (PSNR), or a structural similarity index (SSIM).

22. The method of claim 17, further comprising:
sending, to a computing device, content comprising the encoded second video segment.

23. The method of claim 1, further comprising:
sending, to a computing device, content comprising the encoded video segment.

24. The method of claim 10, further comprising:
sending, to a computing device, content comprising the encoded video segment.

25. The method of claim 1, wherein the quality value is associated with a desired level of quality.
